(19) United States
(12) Patent Application Publication
(10) Pub. No.: US 2011/0283951 A1
(43) Pub. Date: Nov. 24, 2011

(54) PET HOUSE

(76) Inventors: WEN-YING KUO, Kangde St. Zhunan Township (TW); CHIN-YU CHIU, Luzhu Township (TW)

(21) Appl. No.: 13/111,304

(22) Filed: May 19, 2011

(30) Foreign Application Priority Data
May 19, 2010 (TW) 099209424

(51) Int. Cl. A01K 1/00; A01K 13/00

(52) U.S. Cl. 119/416; 119/600

(57) ABSTRACT

The pet house of the invention includes a polygonal main structure defined by at least three upstanding lateral plates, each plate includes at least two engagement slots, wherein adjacent engagement slots of adjoining lateral plates inter-engage to each receive a portion of the adjoining lateral plate so that the adjoining lateral plates are fastened together through their adjacent engagement slots, to thereby form a pet enclosure within the polygonal main structure.

### FIELD OF THE INVENTION

The present invention pertains to a pet house, and particularly pertains to a multi-function pet house.

### BACKGROUND OF THE INVENTION

More and more people are thinking of their pets as important family members, instead of simply playmates. It is usual to spend much money to build a comfortable living house or space for pets. Among the supplies for pets, a pet house is always the first stuff to be bought as compared with other pet suppliers such as pet cleaners, pet clothes, and pet medical supplies, because it provides a space for resting, playing and eating.

Most of conventional pet houses, such as cats and dogs, are heavy so that it is hard to disassemble, clean, transport or carry these pet houses. Further, it needs a large space to store the pet houses. To solve the problems of the conventional pet houses, for example, a pet house which can be disassembled and assembled, was designed and disclosed in U.S. Pat. No. 7,322,315. It provides a pet house constructed of many components such as plastic tubes, three-way pipes, and four-way pipes. However, it is time-consuming and laborious to build this pet house because there are too many components. It is still desirous to have a pet house that is made of light material, and can be easily and conveniently disassembled and assembled.

### BRIEF SUMMARY OF THE INVENTION

Accordingly, the purpose of the present invention is to provide a pet house which is rigid but can easily assembled and disassembled. In addition, it provides some more functions, like scratching boards or pet hair dryer room.

One object of the present invention is to provide a pet house including a polygonal main structure defined by at least three upstanding lateral plates. In the pet house according to the present invention, each plate include at least two engagement slots, wherein adjacent engagement slots of adjoining lateral plates inter-engaged to each receive a portion of the adjoining lateral plate so that the adjoining lateral plates are fastened together through their adjacent engagement slots, to thereby form a pet enclosure within the polygonal main structure.

According to the present invention, the engagement slots of each lateral plate extend from an edge opposite to the edge that the engagement slots of an adjoining lateral plate extend from.

According to the present invention, the pet house may be made of paper, preferably high strength paper. To be more rigid, the lateral plates in a double-layered structure may be used.

In one embodiment of the present invention, the pet house further comprises a roof structure, which includes at least one top plate having engagement slots for engagement with one or more of the lateral plates to secure the roof structure to the main structure.

According to the present invention, one or more of the lateral plates are at least partially hollow, defining therewithin a housing for receiving an insert. In the pet house according to the present, one of the lateral plates has one or more openings in an interior surface to expose at least a portion of an insert to the pet enclosure.

In another embodiment of the present invention, the pet house may further include a bottom plate at the bottom of the main structure, which has an upper surface that forms the bottom of the pet enclosure. In a particular embodiment, the bottom plate is at least partially hollow, defining therewithin a housing for receiving an insert, the bottom plate including an opening in its upper surface that exposes at least a portion of the insert to the pet enclosure.

According to the invention, the insert is a scratcher, such as a scratching board, which is installed in the housing of the plate with at least a portion of the scratcher exposed to the pet enclosure through the opening.

In one particular embodiment of the pet house according to the present invention, at least one lateral plate has an entrance with the entrance connecting to the pet enclosure.

The pet house according to the invention may be for any pets, such as cats or dogs. The pet house can easily assembled and disassembled. And the pet house assembled by such manner can also have rugged structure, which will not easily result in deformations and damages because of the playing of the pets.

To make the foregoing and other purposes, characteristics, and advantages of the present invention more obvious. The preferable embodiments with the appended drawings are used for detailed description as below.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is an illustration of the pet house according to the present invention.

FIG. 2 is an illustration of an exploded view of the main structure of the pet house illustrated in FIG. 1.

FIG. 3 is an illustration of the main structure constructed by four upstanding lateral plates that are hollow defining therewithin a housing for receiving an insert.

FIG. 4 is an illustration of the pet house having a bottom plate.

FIG. 5 is an illustration of the bottom plate being hollow, defining therewithin a housing for receiving an insert, and including an opening in the surface to expose at least a portion of the insert, such as a scratcher, to the pet enclosure.

FIG. 6 is an illustration of the lateral plate being hollow, defining therewithin a housing for receiving an insert.

FIG. 7 and FIG. 8 are the illustrations of the lateral plates being hollow, defining therewithin a housing for receiving an insert, wherein the insert, such as a scratcher, is installed in the housing of the plate.

FIG. 9 is an illustration of the main structure of the pet house according to the present invention, which has some openings in the lateral plates and top plates.

FIG. 10 is an illustration of an exploded view of the main structure of the pet house of FIG. 9.

FIGS. 11A and 11B are the illustrations of the lateral plates being hollow, defining therewithin a housing for receiving an insert, and including one or more openings in the surface to expose at least a portion of the insert, such as a scratcher, to the pet enclosure.

FIG. 12 is an illustration of the main structure of the pet house according to the present invention having one roof plate, which forms a close enclosure functioning as a pet hair dryer room for drying pets' hair.

FIG. 13 is an illustration of the pet house in a single-layered structure, which is not hollow.

FIG. 14 is an illustration of the lateral plates in a single-layered structure, which is not hollow.

FIG. 15 is an illustration of the triangular structure of the pet house of the present invention, constructed by three upstanding lateral plates.

FIG. 16 is an illustration of a lateral plate specifically designed for the triangular structure or the structure constructed by an odd number more than 2, which has one engagement slot at one edge and the other engagement slot at the opposite edge.

### DETAILED DESCRIPTION OF THE INVENTION

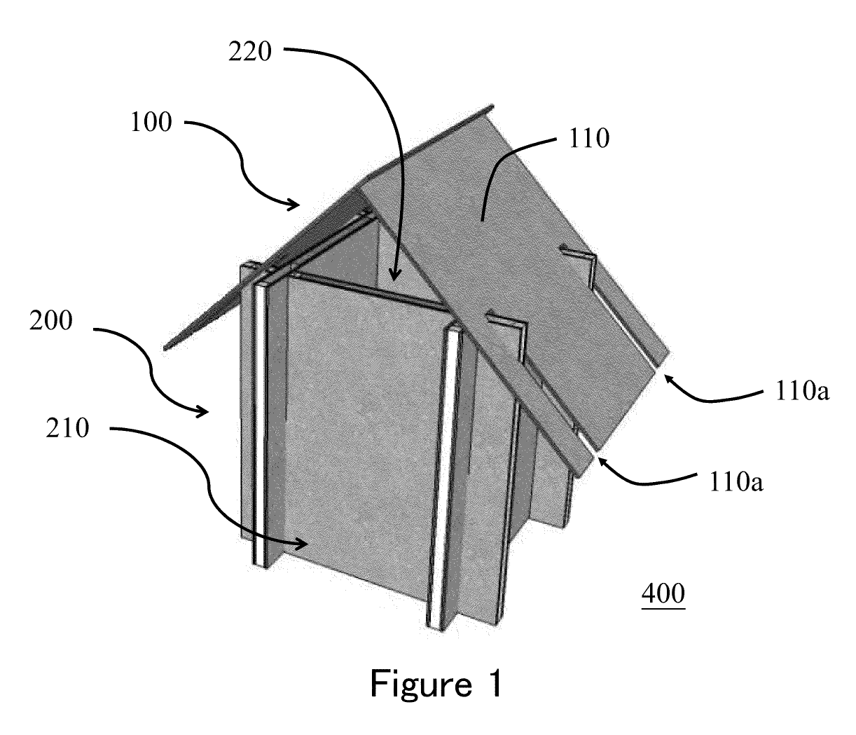

FIG. 1 is an illustration of the structure of the pet house according to the invention, wherein the pet house 400 comprises a polygonal main structure 200 and a roof structure 100, and the roof structure 100 is installed on the top of the polygonal main structure.

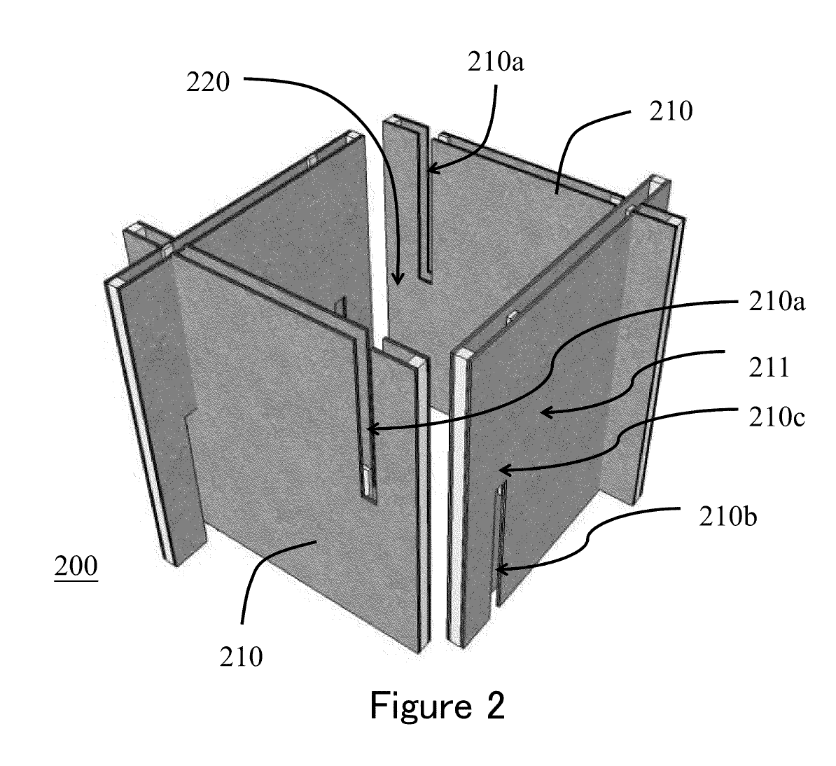

Referring to FIG. 2, the polygonal main structure 200 comprises four upstanding lateral plates 210, 211, and each lateral plate has at least two engagement slots 210a, 210b. For fastening a lateral plates 210 and the adjoining lateral plate 211, the engagement slot 210a is inter-engaged to the adjacent engagement slot 210b of the adjoining lateral plate 211, and the engagement slot 210a receives a portion 210c of the adjoining lateral plate 211 so that the adjoining later plates 210, 211 are fastened together through their adjacent engagement slots 210a, 210b, to hereby form a pet enclosure 220 with the polygonal main structure 200.

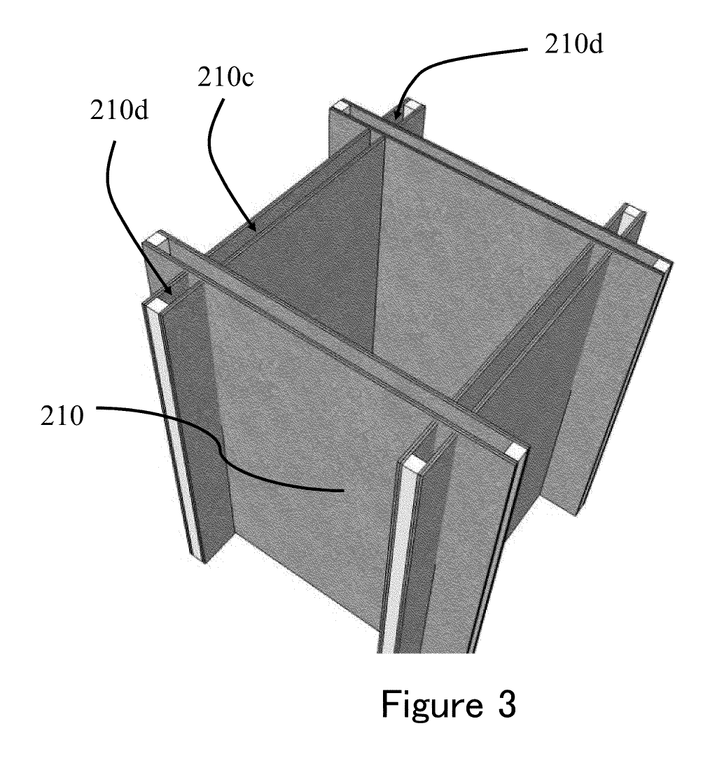

FIG. 2 illustrates one embodiment of the present invention for assembling the upstanding lateral plates. The engagement slots 210a of each lateral plate 210 extend from an edge opposite to the edge that the engagement slots 210b of an adjoining lateral plate 211 extend from. The polygonal main structure 200 is constructed by the upstanding lateral plates 210 and 211 etc. In one embodiment of the invention, the engagement slot 210a of a lateral plate 210 has an length adequate for inter-engaging to the adjoining lateral plate 211. In one embodiment of the invention having a rigid and stable structure 200, the width of an upstanding lateral plate 210 is the same as that of the plate opposite thereto, and the distance between the two slots 210a is the same as that of the lateral plate opposite thereto. T lateral plates 210 are fastened together through the adjacent engagement slots to form a pet enclosure 220 within the polygonal main structure. FIG. 3 is an illustration of the pet enclosure 220 within the polygonal main structure 200, which can be used for a pet to rest, eat, or play.

In addition, as shown in FIG. 1, the roof structure 100 includes at least one top plate 110 having engagement slots 110a for engagement with one or more of the lateral plates 210 to secure the roof structure 100 to the main structure 200.

In the embodiment of the present invention illustrated in FIG. 1 or 2, the main structure 200 are constructed by four upstanding lateral plates 210; however, in other embodiments, the number of the lateral plates is not limited to be four, and can be any number being three or more.

FIG. 3 is an illustration of an embodiment of the present invention, wherein at least one lateral plates 210 is partially hollow, defining therewithin a housing 210c or 210d for receiving an insert.

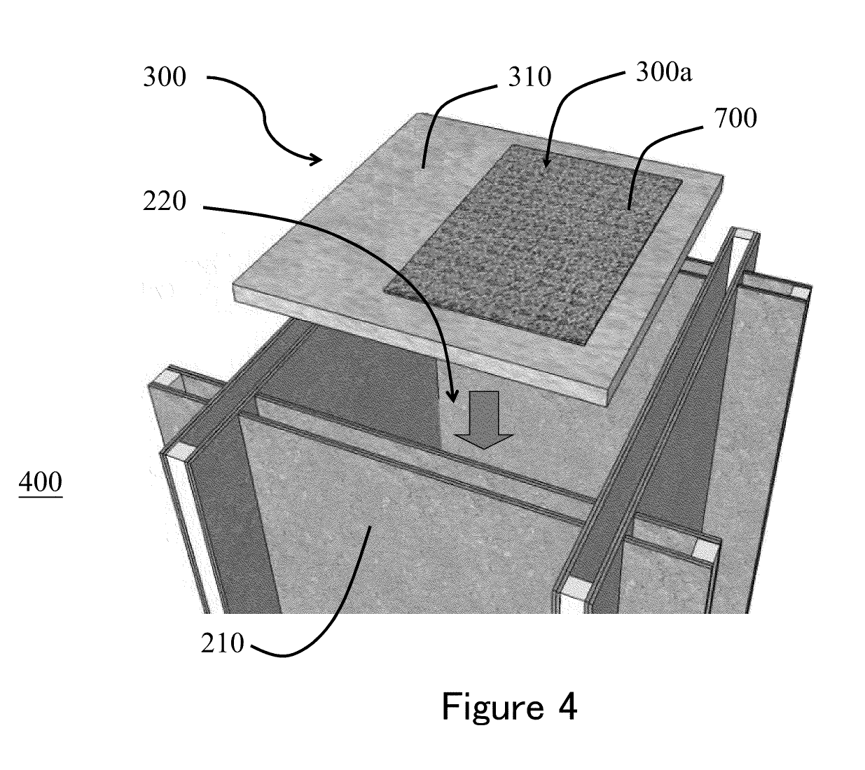

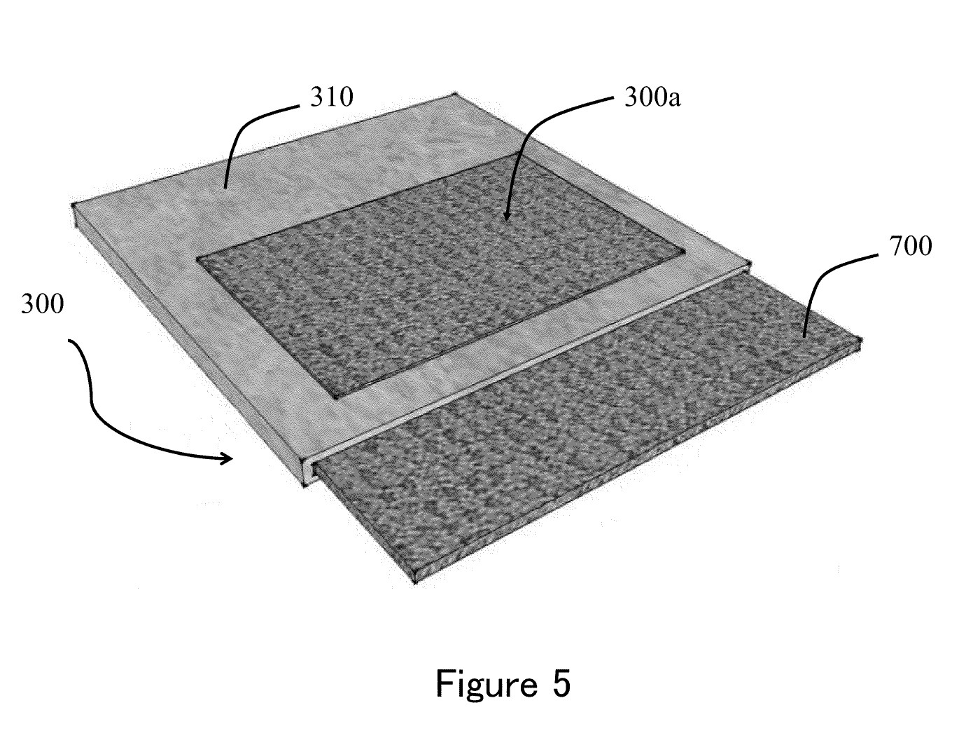

FIG. 4 is an illustrating of an embodiment of the main structure 200 according to the present invention having a bottom plate 300. The pet house 400 includes a bottom plate 300 at the bottom of the main structure, and the bottom plate 300 has an upper surface 310 that forms the bottom of the pet enclosure 220. The bottom plate 300 is at least partially hollow, defining therewithin a housing for receiving an insert 700. As shown in FIG. 5 or FIG. 5, the bottom plate 300 includes at least one opening 300a in its upper surface 310 that exposes at least a portion of the insert 700 to the pet enclosure 220. In one embodiment, the insert 700 is a scratcher, such as a scratching board, installed in the housing with at least a portion of the scratcher exposed to the pet enclosure 220 through the opening 300a.

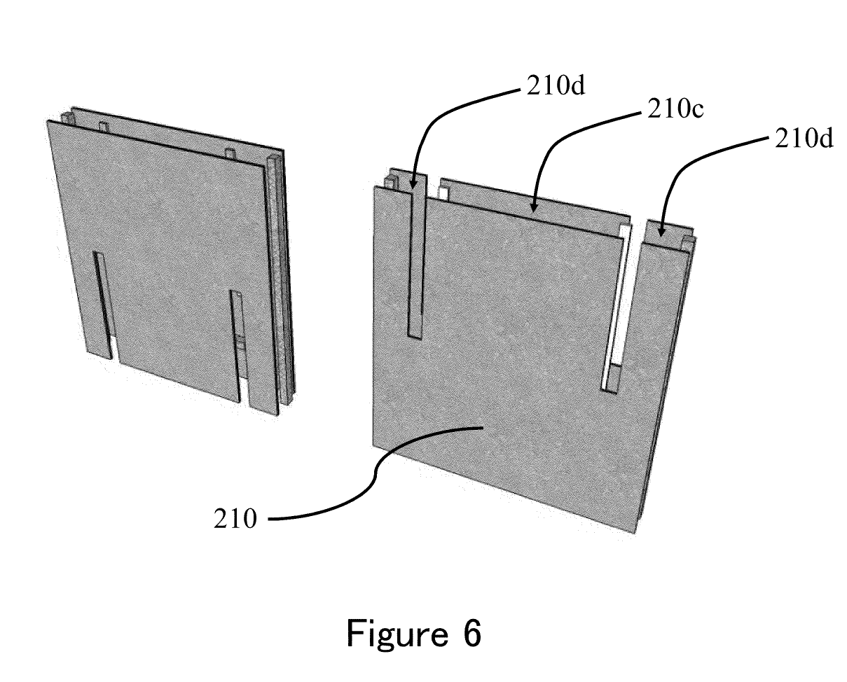

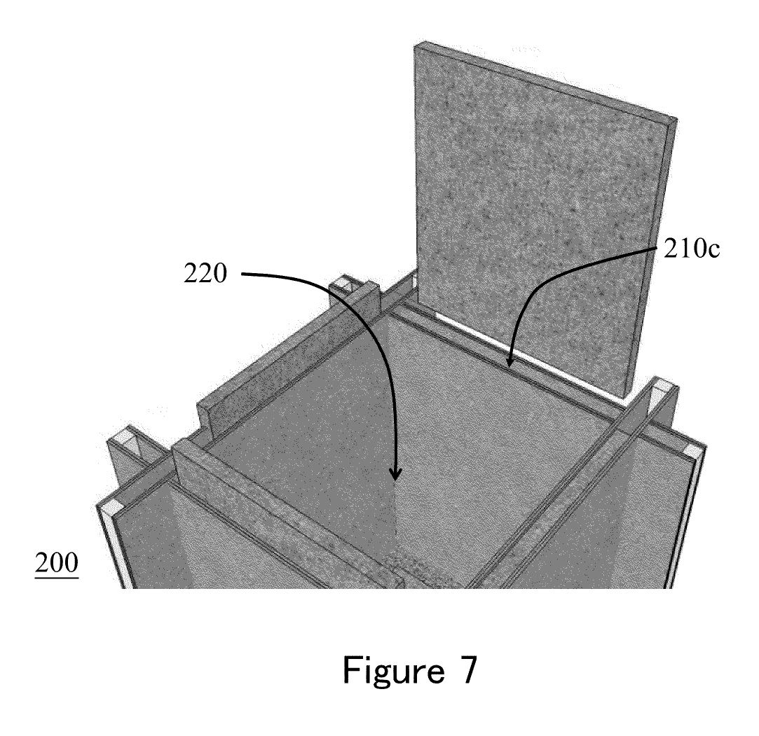

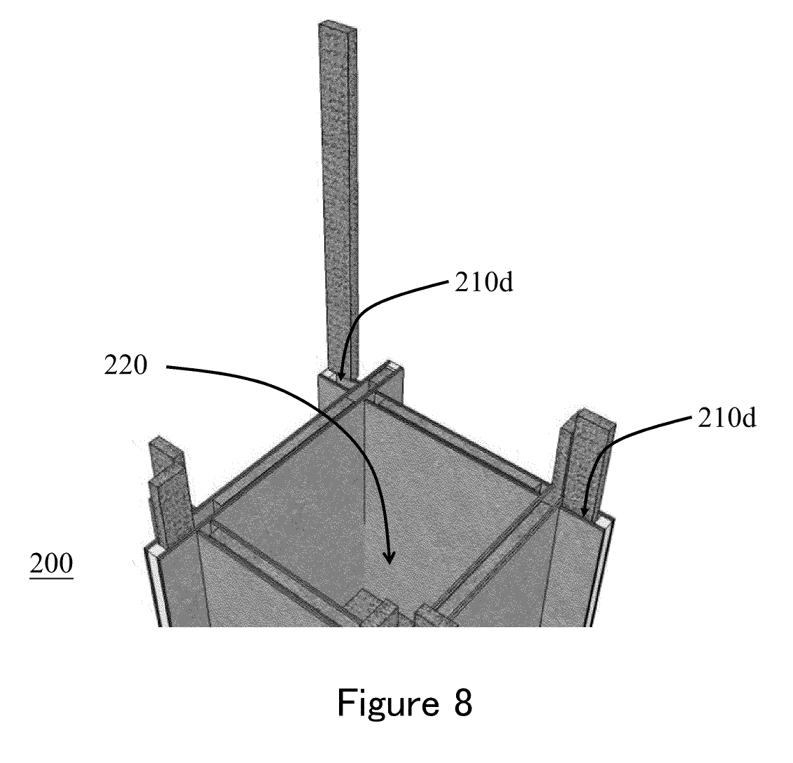

FIG. 6 is an illustration of the lateral plates 210 being hollow, defining therewithin a housing 210c or 210d for receiving an insert. Referring to FIGS. 7 and 8, the insert 700, such as a scratcher like a scratching board, is installed in the housing 210c or 210d of the lateral plate 210.

In one example of the invention, at least one lateral plate has an entrance with the entrance connecting to the pet enclosure.

According to the present invention, it can be understood that the pet house 400 can be easily assembled and disassembled. The present invention provides a solution to the problems of the conventional pet houses being inconvenient, time-consuming, and laborious to assemble and disassemble. In addition, the present invention has many advantages, for example, being easily transported or carried, being convenient and needing less space required for storage.

### Embodiment 2

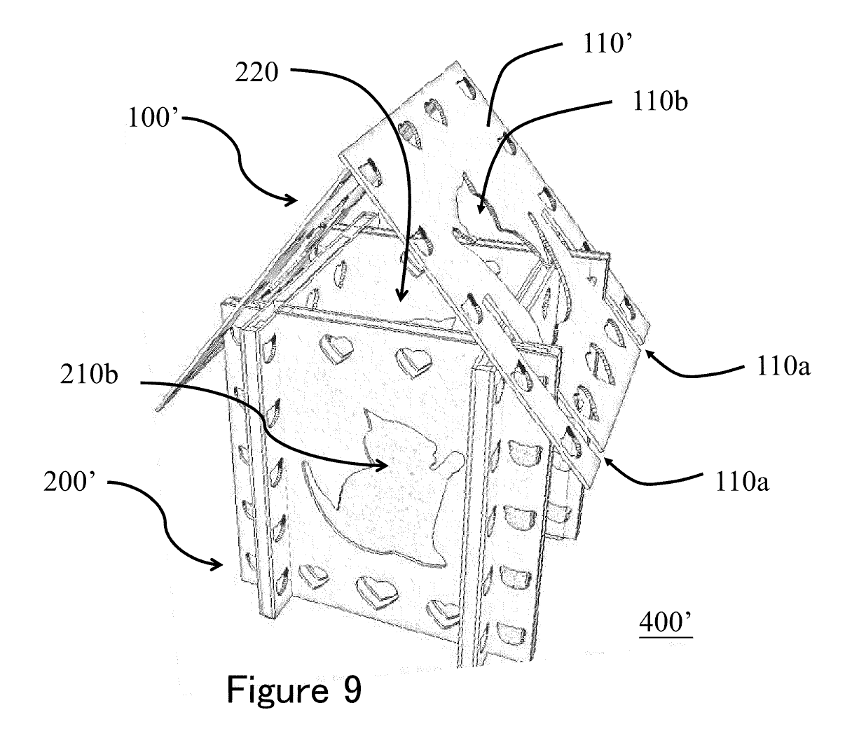

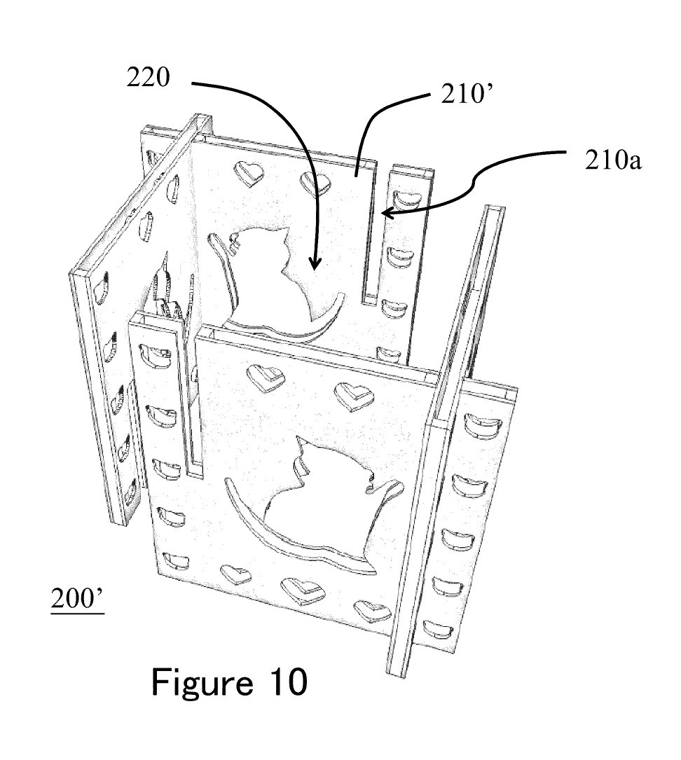

Another embodiment is provided in FIG. 9. Referring to FIGS. 9 and 10, the pet house 400′ comprises a polygonal main structure 200′ constructed by four upstanding lateral plates and a roof structure 100′ that has at least two top plates. The lateral plates and/or top plates have one or more openings. The openings may be designed in various shapes, such as shapes of animals or flowers.

The pet house 400′ has a polygonal main structure 200′ constructed by four upstanding lateral plates 210 and a roof structure having two top plates 110, each of the lateral plates 210 and top plates 110 has at least two engagement slots 210a, and 110a, and also has at least one opening 210b and 110b, respectively. The inserts installed in the housings of the lateral plates are exposed to the pet enclosure through the openings. In addition, the openings in the lateral or top plates provide windows for ventilation or an entrance connecting to the pet enclosure.

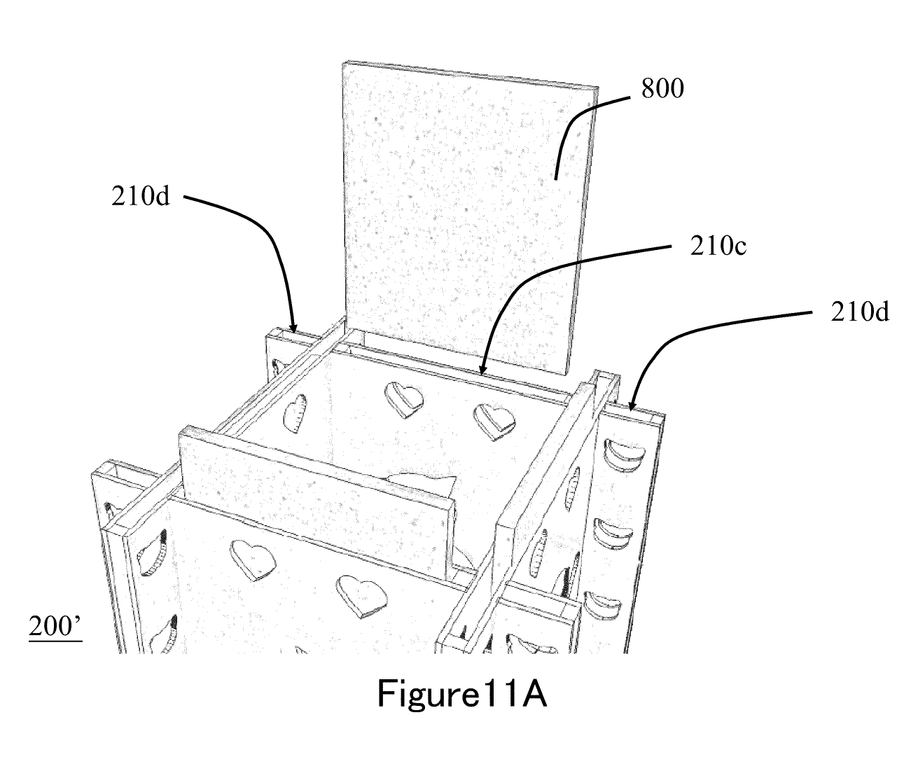

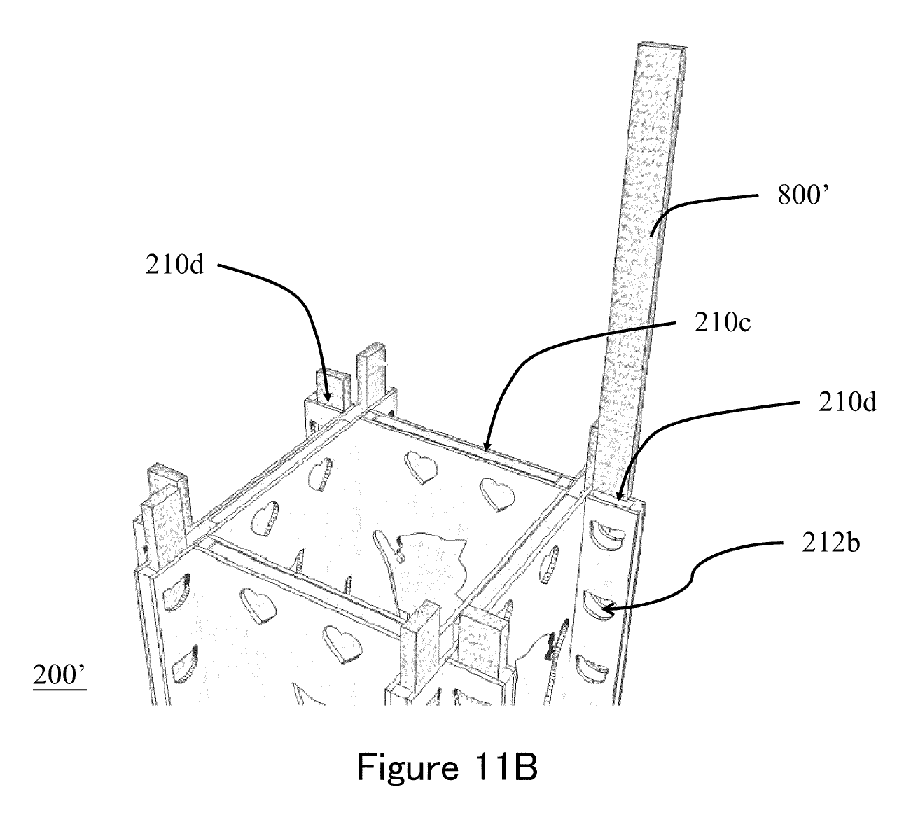

FIGS. 11A and 11B are the illustrations of the main structure 200′ constructed by four upstanding lateral plates 210 being hollow, defining therewithin a housing 210c, 210d for receiving an insert 800, as shown in FIGS. 11A and 11B. At least one lateral plate is not installed by the insert to have an entrance correcting to the pet enclosure.

In the present embodiment, the shape of the opening 110b or 210b is the shape of an outline of cat, but in other embodiments, it can be designed to be any other shapes.

### Embodiment 3

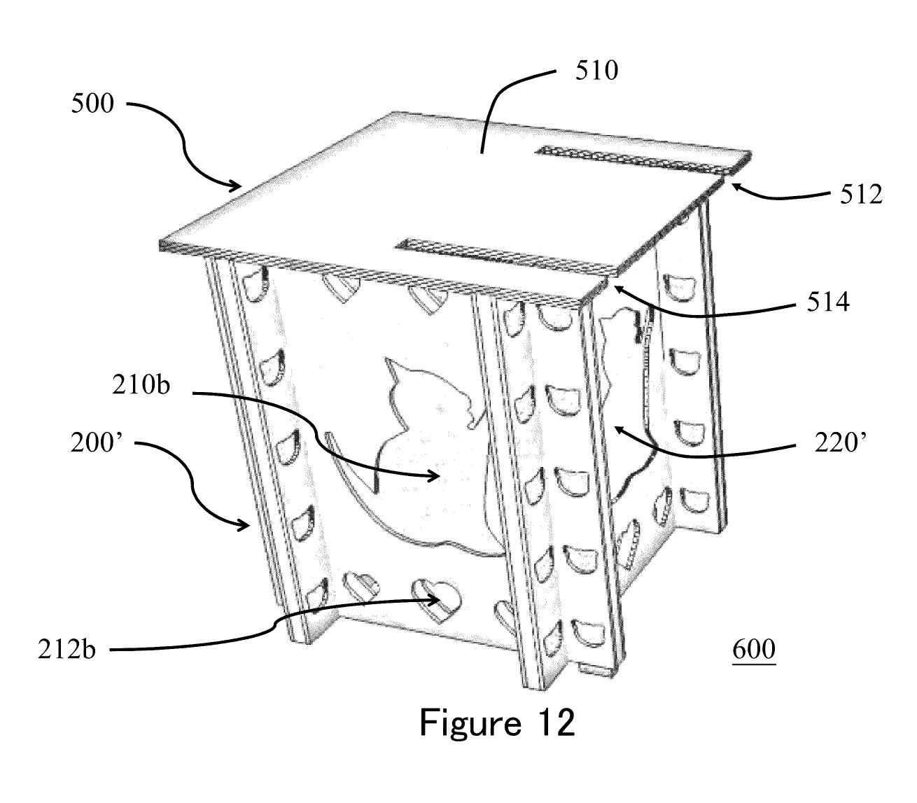

FIG. 12 is an illustration of the pet house 600 having a main structure 200′ and a roof structure 500. The roof structure 500 is a single top plate 510, which is placed on the top of the polygonal main structure 200′, and has several slots or hollows 512 and 514 but without other openings. An enclosure 220′ with only the slots 512, 514 is formed by the main structure 200′ and the root structure 500. The slots 512, 514 provide an air inlet and outlet, respectively. The openings 210b are blocked by the inserts 800 to keep the enclosure closer. The air or hot air can be introduced via one of the slots, such as the slot 512, to the enclosure 220′, which can function as a pet hair dryer room for drying pets' hair. In one example, air or heated air is introduced to the close enclosure by a blower. There are some small openings 212b in the lateral plates to keep open for better ventilation. Accordingly, the pet house 600 provides a comfort space for drying pet hair.

### Embodiment 4

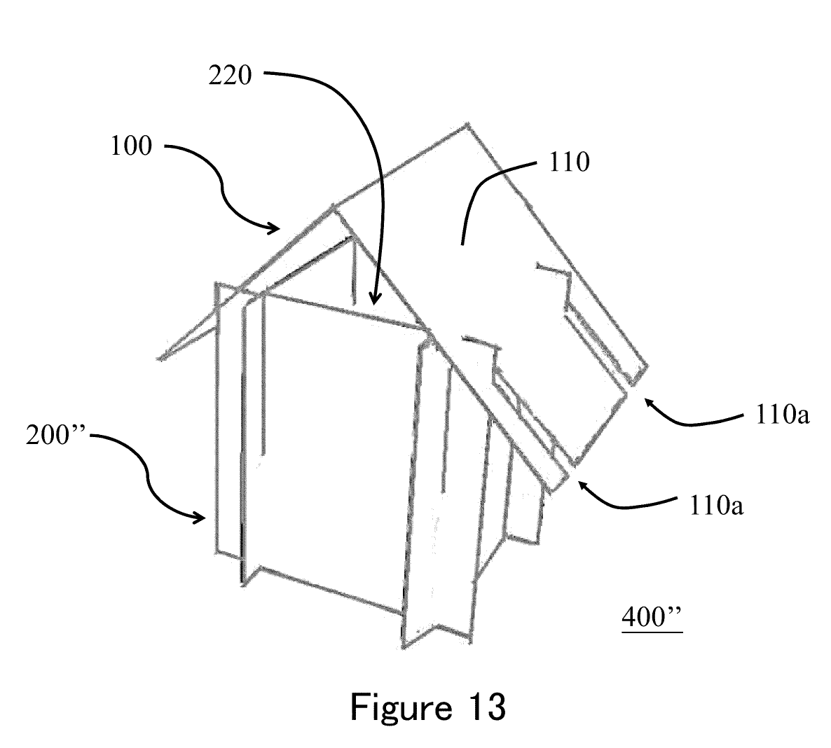

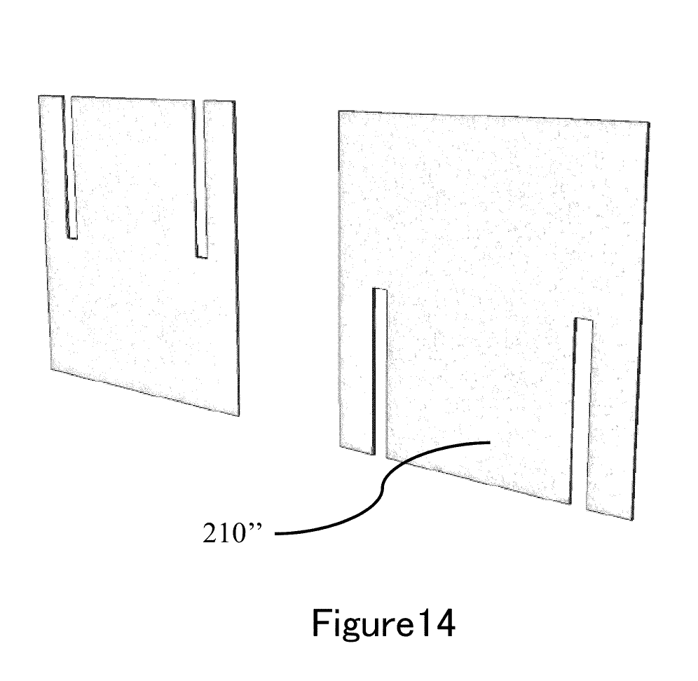

FIG. 13 is an illustration one embodiment of the invention being the pet house 400″ in a single-layered structure (for example, which is made of single-layered paper), comprising a polygonal main structure 200″ and a roof structure 100. As shown in FIGS. 13 and 14, the lateral plates are made of single-layered paper, which is lighter than other pet houses, and it is much easier and less laborious to assemble or disassemble.

### Embodiment 5

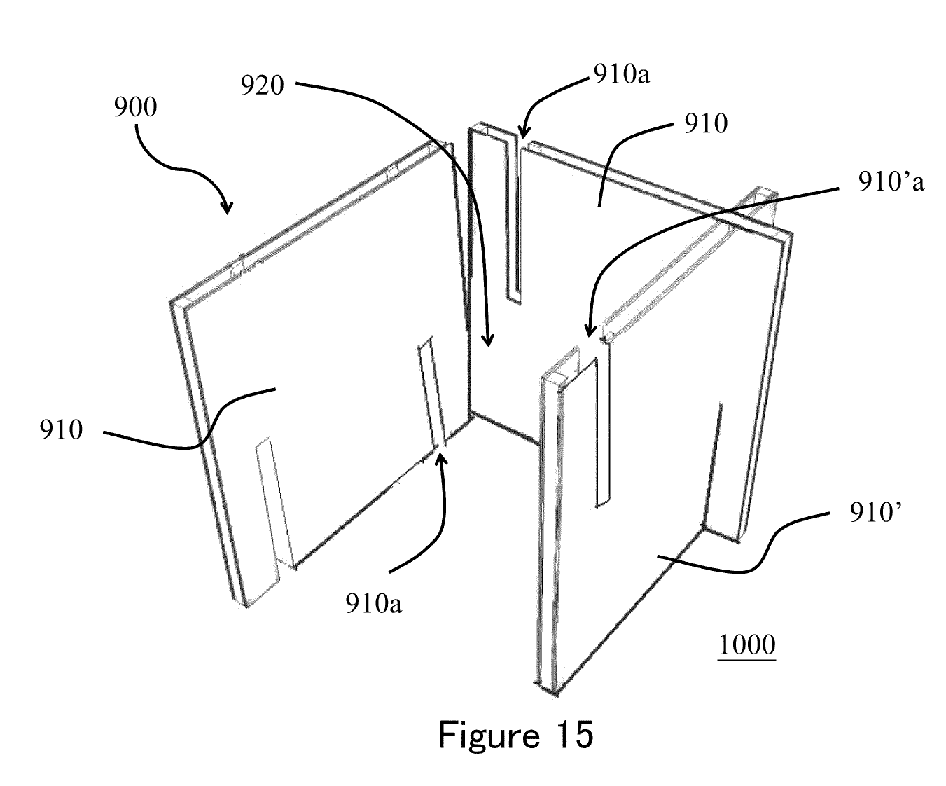

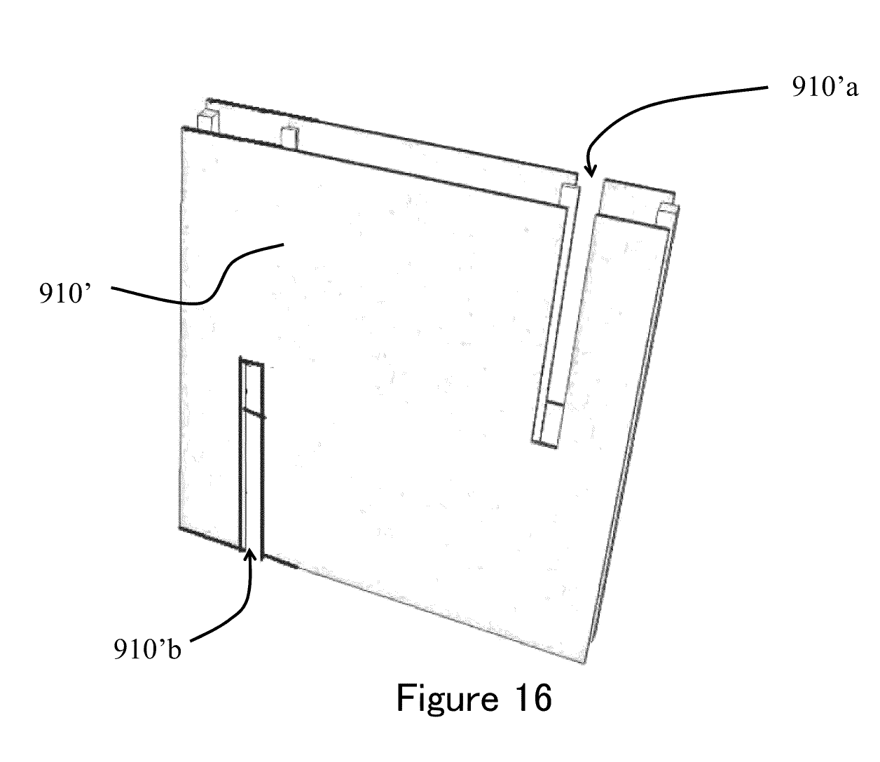

FIG. 15 is an illustration of the other embodiment of the invention being a triangular pet house. Referring to FIGS. 15 and 16, one lateral plate should be designed specifically for the triangular structure or an structure constructed by an odd number more than 2, which has one engagement slot at one edge and the other engagement slot at the opposite edge. Referring to FIGS. 15 and 16, the pet house 1000 comprises a polygonal main structure 900 and a roof structure (not illustrated). The polygonal main structure 900 comprises two lateral plates 910 and one lateral plate 910′ wherein each of the lateral plates 910 has two slots 910a at the same edge. However, the lateral plate 910′ has one engagement slot 910′a at one edge and the other engagement slot 910′b at the opposite edge. To fasten the lateral plates together, the engagement slots of the lateral plates inter-engaged to each receive a portion of the adjoining lateral plate through their adjacent engagement slots to form a pet enclosure.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A pet house including a polygonal main structure defined by at least three upstanding lateral plates, each plate including at least two engagement slots, wherein adjacent engagement slots of adjoining lateral plates inter-engage to each receive a portion of the adjoining lateral plate so that the adjoining lateral plates are fastened together through their adjacent engagement slots, to thereby form a pet enclosure within the polygonal main structure.

2. The pet house of claim 1, wherein the engagement slots of each lateral plate extend from an edge opposite to the edge that the engagement slots of an adjoining lateral plate extend from.

3. The pet house of claim 1, including a roof structure on the polygonal main structure, the roof structure including at least one top plate having engagement slots for engagement with one or more of the lateral plates to secure the roof structure to the polygonal main structure.

4. The pet house of claim 1, including a bottom plate at the bottom of the polygonal main structure, the bottom plate having an upper surface that forms the bottom of the pet enclosure.

5. The pet house of claim 4, wherein the bottom plate is at least partially hollow, defining therewithin a housing for receiving an insert, the bottom plate including an opening in its upper surface that exposes at least a portion of the insert to the pet enclosure.

6. The pet house of claim 5, wherein the insert is a scratcher installed in the housing with at least a portion of the scratcher exposed to the pet enclosure through the opening.

7. The pet house of claim 1, wherein the polygonal main structure consists of four lateral plates.

8. The pet house of claim 1, wherein one or more of the lateral plates are at least partially hollow, defining therewithin a housing for receiving an insert

9. The pet house of claim 8, wherein at least one hollow lateral plate has one or more openings in an interior surface to expose at least a portion of an insert to the pet enclosure.

10. The pet house of claim 9, wherein the insert in a hollow lateral plate is a scratcher installed in the housing of that plate with at least a portion of the scratcher exposed to the pet enclosure through the opening.

11. The pet house of claim 1, wherein at least one lateral plate has an entrance with the entrance connecting to the pet enclosure.

12. The pet house of claim 1, further comprising a roof structure being a single plate, wherein an enclosure is formed by the main structure and the roof structure, which functions as a pet hair dryer room.
